(19) United States
(12) Patent Application Publication
(10) Pub. No.: US 2010/0116179 A1
(43) Pub. Date: May 13, 2010

(54) Polyurethane composite matrix material and composite thereof

(76) Inventors: Charles H. Baker, Overland Park, KS (US); Virgil Smail, Manhattan, KS (US)

Correspondence Address: Eileen M. Ebel;BRYAN CAVE LLP, 1290 Avenue of the Americas, New York, NY, 10104, US

(21) Appl. No.: 12/587,944

(22) Filed: Oct. 14, 2009

Related U.S. Application Data
(60) Provisional application No. 61/196,310, filed on Oct. 15, 2008.

(51) Int. Cl. B32B 27/40; B65D 19/38; B32B 27/04; B65D 19/32; B32B 5/16

(52) U.S. Cl. 108/57.25; 428/317.9; 428/324; 428/325; 428/327; 428/331

(57) ABSTRACT

The present invention provides a composite matrix material which has (a) polyurethane; (b) inorganic particles which have outer surfaces and an aspect ratio of from at least about 1.5 to about 30; and (c) a silane coupling agent; wherein at least a portion of outer surfaces of the inorganic particles are in contact with the silane coupling agent. Also provided is a composite in which a composite matrix material is a polymeric matrix core which has a surface, and a thermoset layer is bonded to at least a portion of the surface of the polymeric matrix core. The composite is a high strength, durable part that may be used, for example, in manufacturing pallets and building or construction materials such as deck boards and siding and roofing panels, etc.

### RELATED APPLICATIONS

The present application claims the benefit under 35 USC §119(e) of U.S. Provisional Application No. 61/196,310, which was filed on Oct. 15, 2008, and which is incorporated by reference herein in its entirety for all purposes.

### BACKGROUND OF THE INVENTION

In the United States, sales of wood products exceed $200 billion annually. Building products are perhaps the most important segment of this market, and their sales may exceed $100 billion annually. Wood is easily fabricated, is relatively low cost, and has a remarkable strength-to-weight ratio. Wood products are used in many types of building materials, e.g., decking, siding, framing, roofing, and fencing. Wood has several drawbacks, however. It degrades rapidly in the presence of moisture and has anisotropic mechanical properties, poor UV resistance, and poor dimensional stability. Wood products must be periodically treated or coated to protect them in most applications. Even with regular maintenance, it is often necessary to replace wood products after a relatively short period of time as compared to the lifetime of a building or other construction project.

Polymer wood composite (“PWC”) materials have begun to replace wood in non-structural applications, such as decking. These composite materials are conventionally made by profile extruding a blend of wood-filled polyolefins and/or polyvinylchloride. PWC materials have gained rapid acceptance in the marketplace because they are almost maintenance-free and are more resistant to the environment than conventional wood products. Despite the fact that these products have been sold for only 10-15 years, they constitute a market worth several billion dollars annually with double-digit annual growth.

However, PWC materials sell at a 2- to 3-fold premium over wood products. This premium can be expected to increase as oil prices continue to rise. PWC materials also have significantly lower strength-to-weight ratios compared to those of wood products. In some cases, PWC materials have strength-to-weight ratios less than one-tenth of those of comparable wood products. Accordingly, use of PWC materials has been limited to non-structural applications.

Wood is used as a filler in such composites because it is low cost (about $0.10/pound), readily available, and yields an end product resembling in appearance the wood material it replaces. However, the use of wood as a filler in composite materials has significant drawbacks. PWC materials easily fade, suffer tannin staining, are heavy, i.e., have a density about 1.1 grams per cubic centimeter (2 to 3 times the density of pine, a typical building material), and are difficult to manufacture. Variable characteristics of the starting materials such as moisture content cause inconsistent dimensions in the resulting product unless adaptations are made to the process to account for these variations.

Alternatives to wood fillers have been considered, but none have demonstrated a significant cost-benefit advantage. For example, use of a mineral filler, such as talc or mica, produces a composite product that is much heavier and more brittle than a PWC product. Light-weight, non-wood materials have also been considered. They usually consist of a void that is surrounded by a thin layer of material, resulting in a low-density structure. Use of these low-density structures in conventional products using conventional processes renders them susceptible to crushing, which impedes the use of such structures as light-weight or low density fillers.

Most current PWC composites have a polyolefin polymer matrix, and extrusion processes are utilized to melt the polymer and encapsulate the filler. However, extrusion processes are characterized by high temperature and pressure, and if used with light-weight, non-wood fillers, those processes crush the fillers and produce composite materials that are much heavier than PWC products. Also, the extrusion equipment must be designed to produce and withstand those high pressures and temperatures, which adds cost. Furthermore, extrusion products must be cooled at the end of production before further processing or handling, which increases production cost.

Polymeric thermosetting resins are also used to manufacture composites in which strength is required in the end application, for example, in weight-bearing uses. A resin that imparts strength such as epoxy has been used. Where high strength is required, an approach has been to add a layer of fiber having infinite length (infinite aspect ratio) and which provides strength in both directions (e.g., from the weave of a mat such as fiberglass mat). As epoxy and fiber mat are not sufficiently compatible materials to form a strong bond directly, however, a binder layer may be used in between the mat and epoxy. Excellent strength has been obtained, for example, using the composite of U.S. Publication 2008-0187739, which is incorporated by reference herein in its entirety for all purposes.

When strength is needed but not to the extent for which a mat layer would be required, an alternative has been to strengthen a resin by adding a filler such as a mineral filler which can be, for example, talc, calcium carbonate, etc. Mineral filler is ground to a fine powder before being introduced to the polymeric material. Low aspect ratio mineral filler can also decrease the expense of making the part produced.

Rigid (non-foaming) polyurethane is not as strong as epoxy, so it has generally not been used in high-strength applications, for example, with a mat layer. Polyurethane has been used, however, with added fillers to extend and lower the cost of the part. The weight of the filler can also impart a small degree of added strength. Yet light weight fillers are useful to offset the weight of the resin at the expense of added strength.

Foamable polyurethane is soft and deformable and is generally not used for applications requiring strength. Advances have been made in rendering foamable polyurethane rigid such that it can be used in composite materials to fill space and act as an energy sink to diminish the effect of impact on the composite. Such rigid foamed polyurethanes can be used as a core material for composites, for example, as in U.S. Publication 2008-0187739. Suitable strength has not been achieved in a foamed polyurethane composite material without compensating, for example, with one or more layers of reinforcing material such as fibrous mat mentioned above.

Alternatively, fillers have been added to a foamed polyurethane, but the foam remains weak and unstructured. Although some improvement in strength is seen by rendering a foam rigid, the foam will still typically yield or collapse upon direct impact of sufficient force. Fillers can add weight and in that respect, excess weight has served to compensate for lack of inherent strength. Foamable polyurethane has been loaded with heavy filler material such as fly ash. The addition of this much weight to a part is not always desirable.

It would be advantageous to have composites that come closer to the strength-to-weight ratio and other mechanical properties of wood, have densities lower than wood, and are low cost. It would also be advantageous to have methods of making such composites where the methods do not have the drawbacks of extrusion processes. It would also be beneficial to have a strong yet light-weight and impact resistant composite that can be manufactured in a simple and streamlined manner.

### SUMMARY OF THE INVENTION

The present invention provides a composite matrix material that is a rigid, light-weight and impact resistant part, yet also with a degree of strength and structural integrity. The composite matrix material comprises: (a) polyurethane; (b) inorganic particles which have outer surfaces and an aspect ratio of from at least about 1.5 to about 30; and (c) a silane coupling agent; wherein at least a portion of outer surfaces of the inorganic particles are in contact with the silane coupling agent. The polyurethane used in accordance with the invention may be either a non-foamable or a foamable type of polyurethane.

In a preferred aspect of the invention, a composite is provided which has a polymeric matrix material of polyurethane, and a thermoset layer. The polyurethane matrix material has some degree of strength such that a composite strength layer need not compensate with high strength. Thus, a strength layer may be used that does not impart as great a degree of strength as would otherwise be used to obtain a given resulting composite strength. A strength layer in accordance with the present invention is preferably a thermoset layer which is bonded to at least a portion of the surface of the polymeric matrix core. The composite provides a strong and impact resistant part that may be used for example, for building or construction uses, and that may be manufactured in a simple and streamlined manner. Furthermore, the composite can advantageously be a light-weight material. In another advantageous aspect, the core material of the composite has structural integrity and maintains the integrity of its boundaries, i.e., its dimensions do not readily contract over time or with wear.

A composite in accordance with the present invention comprises: (i) a polymeric matrix core which has a surface, wherein the polymeric matrix core comprises: (a) polyurethane; (b) inorganic particles which have outer surfaces and an aspect ratio of from at least about 1.5 to about 30; and (c) a silane coupling agent; wherein at least a portion of outer surfaces of the inorganic particles are in contact with the silane coupling agent; and (ii) a thermoset layer which is bonded to at least a portion of the surface of the polymeric matrix core.

### DETAILED DESCRIPTION OF THE INVENTION

The present invention provides a composite matrix material that is a rigid, light-weight and impact resistant part, yet also with a degree of strength and structural integrity. The composite matrix material comprises: (a) polyurethane; (b) inorganic particles which have outer surfaces and an aspect ratio of from at least about 1.5 to about 30; and (c) a silane coupling agent; wherein at least a portion of outer surfaces of the inorganic particles are in contact with the silane coupling agent. The polyurethane used in accordance with the invention may be either a non-foamable or a foamable type of polyurethane.

The composite matrix material preferably has from about 30 to about 90 weight percent polyurethane based on the weight of the composite matrix material.

In a preferable embodiment, the polyurethane is a foamed polyurethane. The amount of foaming polyurethane used may be in accordance with the manufacturer's recommended amount for filling foam into a given cubic measure. Preferably, more polyurethane is used than the recommended amount. For example, rather than using the manufacturer's suggested amount to foam into a 3 pound per cubic foot space, twice that amount may be used. The resulting foamed material is thus more dense than a foamed material using the suggested amount.

The inorganic particles of the present invention are minerals that are fiber-like. They have an aspect ratio of from about 1.5 to about 30. The aspect ratio permits the silane coupling agent that is in contact with the mineral surfaces to modify the outer surfaces of the inorganic particles by bonding to them. In a preferred embodiment, the inorganic particles include particles having an aspect ratio of from about 5 to about 25. In a further preferred embodiment, the inorganic particles include particles having an aspect ratio of from about 10 to about 25. More preferably, the inorganic particles include particles having an aspect ratio of from about 10 to about 20. Most preferably, the inorganic particles include particles having an aspect ratio of from about 15 to about 20. It is also preferable that for each of the preferable aspect ratio ranges, at least about 60 percent of the inorganic particles of the composite matrix material have the aspect ratio ranges identified.

The inorganic particles of the composite matrix material can measure from about 10 to about 200 microns in at least one dimension. In a preferred embodiment, the inorganic particles include particles having from about 25 to about 150 microns in at least one dimension.

In a preferred embodiment, the inorganic particles are minerals that include silicon molecules. Without wishing to be bound to a particular theory, it is believed that the silane coupling agent binds well to silicon molecules or to silicon molecule-containing moieties of the inorganic particles.

Inorganic particles of the invention may include, for example, expanded volcanic ash particles that are not perfectly spherical, but which have an aspect ratio, for example, of at least about 1.5. Expanded volcanic ash particles can have an aspect ratio at the upper range of about 3. It is also noted that expanded volcanic ash may also be used in accordance with the present invention as a low density filler.

The preferred inorganic particles of the present invention are wollastonite particles. Wollastonite is calcium metasilicate, having the formula CaSiO₃. A large percentage of wollastonite particles have an aspect ratio from about 17 to about 20, which is a most preferred range of aspect ratio in the present invention. Wollastonite and wollastinite may be used interchangeably, as wollastinite often refers to a fiber-like particle of wollastonite. “Wollastonite” as used herein encompasses wollastinite.

The inorganic particles may be present, for example, from about 5 to about 80 weight percent based on the weight of the composite matrix material. Preferably, the inorganic particles are from about 5 to about 70 weight percent based on the weight of the composite matrix material.

Coupling agents are chemicals used to provide a stable bond between two otherwise nonbonding and/or incompatible surfaces. Silane coupling agents are organosilicon compounds having a generic chemical structure Y—Si(OR)₃ in which at least two reactive groups of different types are bonded to a silicon atom in a molecule. One of the reactive groups represented by (OR)₃ may be, for example, a methoxy, ethoxy, or silanolic hydroxy group, etc., and can react with various inorganic materials such as glass, metals, silica sand, etc., to form a chemical bond with the surface of the inorganic material. The other reactive group, Y, is an organofunctional group which may be, for example, vinyl, expoxy, methacryloxy, acryloxy, amino, ureido, cholorpropyl, mercapto, sulfido, or isocyanate, and which can react with various kinds of organic materials or synthetic resins to form a chemical bond. For example, an epoxy silane compound can be used to modify an epoxy resin. Such epoxy silane modified resins can be used, for instance, as sealants.

Unexpectedly, polyurethane, and particularly foamable polyurethane, is strengthened considerably by the addition of wollastonite and an amino silane compound, which results in the formation of a matrix material. Thus it has been found that an amino silane compound acts as a silane coupling agent in a foaming polyurethane system. Advantageously, a composite matrix material of the invention having foamed polyurethane provides a rigid, light-weight material having a matrix which provides more strength than has been associated with prior foamed polyurethane systems.

The silane coupling agent is present in an amount in which at least a portion of outer surfaces of the inorganic particles are in contact with the silane coupling agent. For example, the composite matrix material may include a coupling agent in an amount of from about 0.4 to about 5 weight percent based on the weight of the inorganic particles. Preferably, the outer surfaces of the inorganic particles are coated with the coupling agent, such that contact is made between the outer surfaces and the coupling agent over a substantial area of the outer surfaces. The outer surfaces of the inorganic particles may be coated to saturation at about 5 weight percent silane coupling agent based on the weight of the inorganic particles. Greater than about 5 weight percent may be used, although further benefit of additional silane coupling agent may be minimal.

To prepare the composite matrix material, one embodiment involves mixing the coupling agent together with the polyurethane and inorganic particles. This method streamlines processing.

In an alternative embodiment, the outer surfaces of the inorganic particles may be pre-coated with silane coupling agent before being introduced to the polyurethane. This method may provide coating over a greater area of the outer surfaces. The treated inorganic particles are then introduced to the polyurethane. In an embodiment, the outer surfaces of the inorganic particles are coated with the coupling agent by pre-treating in an amount of from about 0.4 to about 5 weight percent based on the weight of the inorganic particles.

In another embodiment, the outer surfaces of the inorganic particles are in contact with the coupling agent and the coupling agent is in an amount of from about 0.5 to about 1.5 weight percent based on the weight of the inorganic particles. In this embodiment, precoating of the inorganic particles is preferred.

Regardless of the manner of introducing silane coupling agent, the outer surfaces of inorganic particles need not be completely coated with silane coupling agent in order for them to be in sufficient contact with the silane coupling agent in accordance with the present invention. It is preferable as indicated above, however, that the outer surfaces be substantially coated.

In one embodiment, the wollastonite may be purchased already pre-coated with an amino silane such as, for example, WOLLASTOCOAT 10222 from NYCO Minerals.

The silane coupling agent that is in contact with the outer surfaces of inorganic particles binds to the inorganic particles. Without being bound by a particular theory, it is believed that the silanolic moiety of the coupling agent binds to the inorganic particles. The silane coupling agent also binds to the polyurethane and thus provides cross-linking to bridge the polyurethane and form a matrix material. Also, the cross-linking advantageously provides greater strength in a non-foamed polyurethane, and a measure of strength in a foamed polyurethane.

In the preferred embodiment, the silane coupling agent is an amino silane coupling agent. It is believed that the amino moiety of the amino silane coupling agent is the functional group that binds to the polyurethane. A strong matrix is formed from the attachments between the inorganic particles and polyurethane. In a further advantageous embodiment, the polyurethane is a foamed polyurethane. A composite matrix material using foamed polyurethane is thus provided. A more preferred embodiment is also provided, which is a lightweight composite matrix material comprising foamed polyurethane.

Functional silane coupling agents other than amino silane will provide some cross-linking, although it is considered that the bond will not be as strong as when using the amino silane coupling agent with polyurethane. An epoxy silane coupling agent may be used, for example. Such a composite matrix material was found to have about 20-25 percent of the strength of a comparable amino silane coupled composite (data not shown).

Silane coupling agents of the present invention may be, in non-limiting example: N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, 3-triethoxysilyl-N-(1,3-dimethyl-butyliden) propylamine, N-phenyl-3-aminopropyltrimethoxysilane, N-(vinylbenzyl)-2-aminoethyl-3-aminopropyltrimethoxysilane hydrochloride, 2-(3,4-epoxycyclohexyl)-ethyltrimethoxysilane, or mixtures of any of the foregoing.

The composite matrix material preferably has an amino silane coupling agent which may be, for example, selected from 3-aminopropyltriethoxysilane or 3-triethoxysilyl-N-(1,3-dimethyl-butyliden) propylamine.

In another aspect of the invention, the composite matrix material further comprises a low density filler. Advantageously, a “filler” in accordance with the present invention does not demonstrate viscoelastic characteristics under the conditions provided. A “low density filler” of the present invention is a light-weight, inert filler material with a density of from about 0.01 to about 0.5 grams per cubic centimeter. A low density filler is useful to keep the weight of the part low. The low density filler may be, for example, expanded volcanic ash, pumice, perlite, pumiscite, vermiculite, glass microspheres, soybean hulls, rice hulls, polymeric microspheres, cenospheres, and mixtures of any of the foregoing. The low density filler is preferably expanded volcanic ash or mixtures comprising expanded volcanic ash.

Additional material that is useful to impart rigidity to the composite matrix material can also be added, for example, sucrose.

The composite matrix material preferably has a flexural modulus of from about 50,000 to about 150,000 pounds per square inch, and a shear modulus of from about 50 to about 500 pounds per square inch.

The polyurethane composite matrix material not only imparts strength, but is also preferably a low density material. The composite matrix material preferably has a density of from about 0.1 to about 0.7 grams per cubic centimeter. The density may be higher depending on the type and amount of filler used.

In another aspect of the invention, the (a) polyurethane, the (b) inorganic particles, and the (c) silane coupling agent of the composite matrix material comprise a polymeric matrix layer which has at least one surface. In this embodiment, the composite matrix material also has a skin which is adhered to at least a portion of the surface of the polymeric matrix layer. The skin preferably is a paint or a thermoset resin selected from the group consisting of polyureas, acrylics, non-rigid, non-foaming polyurethanes, and epoxies. The thermoset resin optionally comprises a low density filler or a reinforcing filler.

A more preferred embodiment of a composite matrix material of the present invention comprises: (a) polyurethane; (b) silicon-containing inorganic particles which have outer surfaces and an aspect ratio of from about 10 to about 25; and (c) an amino silane coupling agent; wherein the outer surfaces of the silicon-containing inorganic particles are in contact with the amino silane coupling agent and the amino silane coupling agent is in an amount of from about 0.5 to about 5 weight percent based on the weight of the inorganic particles. This embodiment is referred to as the more preferred embodiment of the composite matrix material.

Further embodiments of the more preferred embodiment of the composite matrix material include each of the following. It is preferred that the polyurethane is a foamed polyurethane. In another preferred embodiment, the inorganic particles are wollastonite particles. Regarding the amino silane coupling agent, the coupling agent is preferably in an amount of from about 0.5 to about 1.5 weight percent based on the weight of the inorganic particles. Preferably, the outer surfaces are coated by pre-treating with the amino silane coupling agent. The more preferred composite matrix material preferably has a density of from about 0.1 to about 0.7 grams per cubic centimeter, a flexural modulus of from about 50,000 to about 150,000 pounds per square inch, and a shear modulus of from about 50 to about 500 pounds per square inch. In another embodiment of the more preferred embodiment, the composite matrix material comprises a polymeric matrix layer which has at least one surface, and the composite matrix material further comprises a skin which is adhered to at least a portion of the surface of the polymeric matrix layer. The skin is preferably selected from paint or a thermoset resin selected from the group consisting of polyureas, acrylics, non-rigid, non-foaming polyurethanes, and epoxies, and the thermoset resin optionally comprises a low density filler or a reinforcing filler.

In a preferred aspect of the invention, a composite is provided which has a polymeric matrix material of polyurethane, and a thermoset layer. The polyurethane matrix material has some degree of strength such that a composite strength layer need not compensate with high strength. Thus, a strength layer may be used that does not impart as great a degree of strength as would otherwise be used to obtain a given resulting composite strength. A strength layer in accordance with the present invention is preferably a thermoset layer which is bonded to at least a portion of the surface of the polymeric matrix core. The composite provides a strong building or construction material with impact resistance that may be manufactured in a simple and streamlined manner. Furthermore, the composite can advantageously be a light-weight material. In another advantageous aspect, the core material of the composite maintains the integrity of its boundaries and does not readily contract its dimensions over time or with wear.

A composite in accordance with the present invention comprises: (i) a polymeric matrix core which has a surface, wherein the polymeric matrix core comprises: (a) polyurethane; (b) inorganic particles which have outer surfaces and an aspect ratio of from at least about 1.5 to about 30; and (c) a silane coupling agent; wherein at least a portion of outer surfaces of the inorganic particles are in contact with the silane coupling agent; and (ii) a thermoset layer which is bonded to at least a portion of the surface of the polymeric matrix core.

The polymeric matrix core of the composite of the present invention is much like the composite matrix material discussed above, and when the composite matrix material has a skin or other additional layer, the polymeric matrix core of the composite is comparable to what is referred to as the polymeric matrix layer of the composite matrix material. Embodiments of the polymeric matrix core of the composite include all of the embodiments of the composite matrix material or, where referenced, the polymeric matrix layer thereof. For example, the polyurethane of the polymeric matrix core is preferably a foamed polyurethane.

In the composite of the present invention, the polymeric matrix core or the thermoset layer can optionally independently further comprise a low density filler. Both layers may comprise a low density filler.

When the polymeric matrix core comprises a low density filler, it is preferably present up to about 40 percent by weight based on the weight of the polymeric matrix core. Also preferably, the inorganic particles are wollastonite particles, and the polymeric matrix core further comprises a low density filler which is expanded volcanic ash or mixtures comprising expanded volcanic ash. Also preferably, the wollastonite and the expanded volcanic ash are in a ratio of from 45:55 to 55:45 by volume, preferably 50:50 by volume. Further preferably, the wollastonite and the expanded volcanic ash are together from about 5 to about 40 percent by volume of the polymeric matrix core.

In another embodiment of the composite, the polymeric matrix core or the thermoset layer each independently further comprise a reinforcing filler which may be, for example, glass fibers, carbon fibers, cellulosic fibers, mineral filler other than low density mineral filler, glass microspheres, soybean hulls, rice hulls, polymeric microspheres, cenospheres, and blends of any of the foregoing. This includes an embodiment in which the polymeric matrix core and the thermoset layer both have a reinforcing filler. A mineral filler other than low density filler of the present invention may be, for example, silica, talc, calcium carbonate, mica, kaolin, wollastonite, feldspar, barytes, and volcanic ash, or mixtures of any of the foregoing. The glass fiber is preferably up to about 50% by volume of the thermoset layer. Glass fiber of the present invention may be, for example, fiberglass roving or chopped strand. Chopped strand can be prepared from gun roving, for example, by running it through a chopper gun.

When a reinforcing filler is used in the polymeric matrix core, it is preferably up to about 70% weight percent based on the weight of the polymeric matrix core. When the reinforcing filler used is also inorganic particles of the present invention, e.g., wollastonite, then the amount of such material cured with silane coupling agent is considered to be inorganic particles for the purpose of calculating its percentage present.

In an embodiment, the thermoset layer is a thermoset resin that when cured produces a crosslinked or a network polymeric matrix. It may refer to the cured or uncured form depending on usage. The thermoset preferably comprises expanded volcanic ash and glass fiber. In a further embodiment thereof, the thermoset of the thermoset layer is epoxy.

The thermoset of the thermoset layer is a thermoset resin that when cured produces a crosslinked or network polymeric matrix. It may refer to the cured or uncured form depending on usage. The thermoset may be, for example, selected from epoxies, non-foamed polyurethanes, phenol-resorcinol polymers, urea-formaldehyde polymers, polyureas, phenol-formaldehyde polymers, melamine-formaldehyde polymers, soy-based polymers, polyesters, polyimides, acrylics, cyanoacrylates, polyanhydrides, polydicyclopentadienes, polycarbonates, blends of any of the foregoing, and blends of any of the foregoing with at least one linseed oil-based polymer. Preferably, the thermoset of the thermoset layer is epoxy or a blend of thermosets comprising epoxy.

To further strengthen the thermoset layer, a silane coupling agent may be included. If epoxy is used as the thermoset resin, then the preferred silane coupling agent is an epoxy silane coupling agent. When a silane coupling agent is used, it is further preferred to include an inorganic filler such as, for example, expanded volcanic ash.

The composite of the present invention may have a specific gravity of from about 0.20 grams per cubic centimeter to about 2 grams per centimeter or higher. Preferably, the composite has a specific gravity of from about 0.20 grams per cubic centimeter to about 0.8 gram per cubic centimeter.

The composite of the invention preferably has a modulus of elasticity of from about 1,000,000 to about 2,500,000 pounds per square inch, and a shear modulus of from about 2,000 to about 8,000 pounds per square inch.

In an embodiment of the composite, the composite further comprises a skin which is adhered to at least a portion of the outer surface of the composite. The skin may comprise, for example, paint or a thermoset resin selected from the group consisting of polyureas, acrylics, non-rigid, non-foaming polyurethanes, and epoxies, and the thermoset resin optionally comprises a low density filler or a reinforcing filler.

The composite may further comprise an additive such as ultraviolet protectants, compatibilizers, antioxidants, glass fibers, carbon fibers, cellulosic fibers, mineral fibers, heat stabilizers, colorants, flame retardants, insecticides, fungicides, plasticizers, tackifiers, processing aids, foaming agents, impact modifiers and proteins.

In another embodiment, at least one layer of fibrous material is adhered or bonded to at least a portion of the outer surface of the composite. Preferably, the fibrous material layer is adjacent one side of the polymeric matrix core, and the thermoset layer is adjacent the opposite side of the polymeric matrix core when the construction is rectangular.

In a more preferred embodiment of the composite of the invention, the composite comprises: (i) a polymeric matrix core which has a surface, wherein the polymeric matrix core comprises: (a) polyurethane; (b) silicon-containing inorganic particles which have outer surfaces and an aspect ratio of from about 5 to about 25; and (c) an amino silane coupling agent; wherein the outer surfaces of the silicon-containing inorganic particles are in contact with the amino silane coupling agent and the amino silane coupling agent is in an amount of from about 0.5 to about 5 weight percent based on the weight of the inorganic particles; and (ii) a thermoset layer which is bonded to at least a portion of the surface of the core.

The more preferred composite has further embodiments which include each of the following separately or in any combination: where the polyurethane is a foamed polyurethane; where the inorganic particles are wollastonite particles; where the outer surfaces of the silicon-containing inorganic particles are coated with the coupling agent in an amount of from about 0.5 to 1.5 weight percent based on the weight of the inorganic particles, or more preferred, in an amount of about 1 weight percent based on the weight of the inorganic particles; and where the thermoset of the thermoset layer is epoxy or a mixture comprising epoxy.

In further embodiments of the more preferred composite, the composite has a density of from about 0.2 to about 0.8 grams per cubic centimeter, a modulus of elasticity of from about 1,000,000 to about 2,500,000 pounds per square inch, and a shear modulus of from about 2,000 to about 8,000 pounds per square inch.

Also, the core or the thermoset layer of the more preferred composite each independently may further comprise a filler selected from the group consisting of a low density filler or a reinforcing filler. The filler preferably comprises expanded volcanic ash or mixtures of expanded volcanic ash and filler.

The composite matrix material and the composite of the present invention can be manufactured in a simple and cost-effective manner. A stationary or moving mold may be used. The components for preparing polyurethane which are known are mixed and sprayed at high pressure into a stationary mold or onto a traveling mold. For foaming polyurethane, a mixing nozzle is useful given the fast cure time. Also, whichever mold is used, use of a foamable polyurethane calls for a closed mold during the reaction. Furthermore, a blowing agent and means of diffusing a gas phase advantageously need not be used, in accordance with the present invention.

U.S. Publication 2008-0187739 discloses a high strength composite with a rigid core and a laminate having at least one layer of fibrous material and a thermoset binder layer. As noted above, this published application is incorporated by reference herein in its entirety for all purposes. In an aspect of the present invention, some additional strength can be imparted to the rigid core of such a high strength composite. The present invention provides a high-strength composite comprising:

(i) a polymeric matrix core which has a surface, wherein the polymeric matrix core comprises: (a) polyurethane; (b) inorganic particles which have outer surfaces and an aspect ratio of from at least about 1.5 to about 30; and (c) a silane coupling agent; wherein at least a portion of outer surfaces of the inorganic particles are in contact with the silane coupling agent; and

(ii) a laminate bonded to at least a portion of the surface of the core, the laminate comprising: (a) at least one layer of fibrous material having a surface, and (b) at least one layer of thermoset binder which is bonded to at least a portion of the surface of at least one layer of fibrous material, and wherein each thermoset binder layer optionally comprises a low density filler.

In the high-strength composite of the present invention, the laminate thermoset binder layer preferably comprises the low density filler which is expanded volcanic ash or blends comprising expanded volcanic ash.

In preferred embodiments, the polyurethane is a foamed polyurethane, the inorganic particles are wollastonite particles, and the silane coupling agent is an amino silane coupling agent. Further embodiments of the polymeric matrix core including percentages of its components, are as provided above.

The high strength composite may further comprise a thermoset layer which is bonded to at least a portion of the surface of the polymeric matrix core, wherein the thermoset layer optionally comprises a low density filler or a reinforcing filler.

The present invention may be used in a variety of end applications in which strength and durability are useful. Where “a composite according to the present invention” is referred to, a composite or a high-strength composite as referred to herein may be used.

Pallets are an example of an end application in which strength is needed. Composites of the present invention may be used, for example, in manufacturing various types of pallets. A pallet sheet can be made for carrying one or more objects, the pallet sheet comprising: (a) a composite according the present invention that has at least one surface on which the one or more objects rest when being carried on the pallet sheet and wherein the at least one surface defines at least one notch to facilitate moving the pallet; and (b) a skin bonded to at least a portion of the surface of the composite.

Also, a pallet is provided for carrying one or more objects, the pallet comprising: (a) a composite according to the present invention that has at least one surface on which the one or more objects rest when being carried on the pallet and at least one side and wherein the at least one side defines at least one notch to facilitate moving the pallet; (b) a skin bonded to at least a portion of the surface of the composite; and (c) posts connected to the composite.

In another embodiment of a pallet, a pallet is provided for carrying one or more objects, the pallet comprising: (a) at least two composites, wherein at least one of the composites is a composite of the present invention that has at least one surface on which the one or more objects rest when being carried on the pallet and at least one side and wherein the at least one side defines at least one notch to facilitate moving the pallet; (b) a skin bonded to at least a portion of the surface of the at least one composite; and (c) at least two posts, wherein each of the posts is connected to one of the composites such that the posts define a space between the composites when the composites are placed with the posts between them.

In an embodiment of a pallet, the core is made of foamed polyurethane and wollastonite pre-treated with amino silane coupling agent. The thermoset layer is epoxy filled with fiberglass roving and preferably also with expanded volcanic ash. A high pressure spray gun having a fiberglass roving chopper capability to chop glass roving is preferably used to chop glass roving in sections from 0.5 to 3.0 inches in length. The outer layer is polyurea or (non-foaming) polyurethane.

Irregular shaped pallet posts can advantageously be manufactured by batch molding. Molds are mounted on a circular spindle in a clockwise fashion. The spindle turns and causes the molds to pass through several stationary ingredient stations for processing. Precision manufactured aluminum molds which allow easy heat dissipation and having a tolerance of 100 thousandths of an inch are preferred. Pressure on the mold from the reaction using a foaming polyurethane requires a heavy duty mold to contain the pressure across a 40×48 inch surface, for instance.

Pallets in accordance with the present invention may provide a high strength and durable platform for moving objects, at a lower cost to produce. Some pallets such as, for example, the nine post or block pallet with 2 way or 4 way lift entry are subjected to hard use as they are handled mechanically with little regard to their treatment. As such, the life of one of these pallets used in the industry tends to be fairly short, normally lasting three or fewer uses before requiring repair or replacement. Pallets of the present invention, on the other hand, advantageously have long life, strength and durability. Also, when pallets are made with reduced weight composites of the invention, their use can offset freight costs usually associated with pallet weight.

Embodiments of the present invention are useful in many applications, particularly in building and construction uses. A deck board, for example, may be made comprising a composite of the present invention wherein the composite has an outer surface and a skin is adhered to the outer surface and the skin comprises a substance selected from the group consisting of polyureas, acrylics, non-rigid, non-foaming polyurethanes, epoxies, paints, reinforcing fillers, ultraviolet protectants, impact modifiers, antioxidants, low density fillers, wood colorants, impact modifiers, heat stabilizers, flame retardants, insecticides, and fungicides.

Furthermore, a siding or roofing panel may be made comprising a composite of the present invention wherein the composite has an outer surface and a skin is adhered to the outer surface and the skin comprises a substance selected from the group consisting of polyureas, acrylics, non-rigid, non-foaming polyurethanes, epoxies, paints, reinforcing fillers, ultraviolet protectants, impact modifiers, antioxidants, low density fillers, wood colorants, impact modifiers, heat stabilizers, flame retardants, insecticides, and fungicides.

### EXAMPLES

### Example 1

### Comparative Polyurethane Core Formulations

TABLE 1
Flexural Modulus of Foamed Polyurethane Members or Cores
having Various Fillers and/or Reinforcing Layers

| | | | | | FG | | | Flex Mod | D |
|---|---|---|---|---|---|---|---|---|---|
| Sample | PU^{/1} | EVA^{/1} | W^{/2} | Roving^{/3} | Mat^{/4} | Spacer | Epoxy | (PSI) | (g/cc) |
| 1 | 125 | 0 | 0 | 0 | 0 | 0 | No | 19,641 | 0.14 |
| 2 | 125 | 41.3 | 0 | 0 | 0 | 0 | No | 55,550 | 0.17 |
| 3 | 125 | 41.3 | 0 | 0 | 2 (8) | 0 | No | 35,737 | 0.24 |
| 4 | 125 | 41.3 | 0 | 0 | 2 (8) | 1 | No | 69,412 | 0.22 |
| 5 | 125 | 41.3 | 0 | 0 | 4 (16) | 0 | No | 26,776 | 0.24 |
| 6 | 125 | 0 | 0 | 0 | 0 | 0 | Yes | 12,749 | 0.31 |
| 7 | 125 | 41.3 | 0 | 0 | 0 | 0 | Yes | 16,235 | 0.33 |
| 8 | 125 | 41.3 | 0 | 0 | 2 (8) | 0 | Yes | 15,997 | 0.37 |
| 9 | 125 | 41.3 | 0 | 0 | 2 (8) | 1 | Yes | 14,487 | 0.38 |
| 10 | 125 | 41.3 | 0 | 0 | 4 (16) | 0 | Yes | 19,701 | 0.39 |
| 11 | 125 | 41.3 | 0 | 3.3 | 2 (8) | 1 | Yes | 15,005 | 0.42 |
| 12 | 125 | 0 | 41.3 | 0 | 0 | 0 | No | 57,850 | 0.71 |

^{/1}Polyurethane (PU) or expanded volcanic ash (EVA), in grams.
^{/2}W is wollastonite, in grams.
^{/3}Chopper fiberglass Roving throughout PU, in grams.
^{/4}Number of layers of fiberglass (FG) Mat, with grams shown in parenthesis.

The Samples listed in Table 1 were prepared as follows. A 1 inch×5.5 inch×12 inch mold was used for the prepared Samples.

Sample 1 was prepared as the base sample, with only polyurethane in the test piece. The Isocyanate was obtained from Volatile Free, Inc. of Milwaukee, Wis. (VFI 742a). The NB parts of the foamed polyurethane system were carefully weighed out and mixed together in a small mixing vessel. The Isocyanate (A) weight was 68 grams, and the Polyol (B) weight was 57 grams. The mixture was poured into the mold at room temperature and the top clamped to hold the pressure as the part expanded and cured. After a 12 minute cure time the part was removed from the mold and allowed to further cure overnight. Parts were then weighed to determine density and using a simple breakage tester, strength and modulus were determined. This sample was used as the baseline for further testing of other additives and materials.

Sample 2, 3, 4, and 5 were prepared in the manner of Sample 1, although the percentage by weight of polyurethane was altered to be 67% in order to include 33% expanded volcanic ash by weight which was 41.3 grams expanded volcanic ash. Kamco 5 expanded volcanic ash was used which was obtained from Kansas Minerals, Mankato, Kans. The expanded volcanic ash was added and thoroughly mixed with the process stream. Fiberglass mat was added in 0, 2, 2 and 4 layers, respectively. Sample 4 included a regular piece of cardboard as a spacer between the two layers of glass mat. As in Sample 1, these samples were cured in the mold for 12 minutes as before and allowed to cure overnight prior to weighing and testing breakage.

Sample 6 used the same base formulation as Sample 1. In addition, Sample 6 was coated with epoxy obtained from Dow Chemical Company (D.E.R.™ 383 Liquid Epoxy Resin), which was brushed on the surface and the total part allowed to cure overnight. Again the weight and breakage check as in Sample 1 was performed.

Sample 7, 8 and 10 were treated the same as Samples 2, 3 and 4. Additionally, the surface was coated with epoxy and the total sample was cured overnight. Weight and breakage tests were then run on the samples.

Sample 9 was treated the same as Sample 8 with the addition of a regular piece of cardboard used as a spacer between the two layers of glass mat. After curing the part was weighed and break tested.

Sample 11 was treated the same as Sample 9 with the further addition of chopped roving fiberglass added at random throughout the foamed polyurethane. After curing the part was weighed and break tested.

In Sample 12, NYAD WOLLASTOCOAT G wollastonite obtained from NYCO Minerals, Willsboro, N.Y., was used in place of expanded volcanic ash. This sample was treated the same as Sample 2. After curing in the mold and overnight the sample was weighed and breakage tested.

The addition of various fillers and other attempts to strengthen a foamed polyurethane as per Samples 1-12 in Table 1 provided a fair amount of strength, and some Samples better than others, but none provided sufficient strength for higher strength end uses.

### Example 2

### Polyurethane Core

### Formulation with Wollastonite Filler and an Amino Silane

Sample 12 in Table 1 has wollastonite as the filler. When compared to the closest sample having expanded volcanic ash as filler, Sample 2, the wollastonite sample, Sample 12, showed only a slight improvement in flexural modulus (57,850 PSI for Sample 12 as compared to 55,550 PSI for Sample 2.) Wollastonite is heavier than expanded volcanic ash, however, and mixing was not as readily accomplished. Wollastonite particles broke apart during mixing. A lubricant was added in a separate wollastonite sample (Sample 13). The results are shown as follows:

TABLE 2
Flexural Modulus of Foamed Polyurethane Member
having Wollastonite Filler with an Amino Silane

| | | | | Flexural | |
|---|---|---|---|---|---|
| | | | | Modulus | Density |
| Sample | PU^{/1} | W^{/2} | Lubricant | (PSI) | (g/cc) |
| 13 | 125 | 41.3 | Yes | 118,674 | 0.71 |

^{/1}Polyurethane (PU), in grams.
^{/2}Wollastonite (W), in grams.

Sample 13 was prepared in the way that Sample 12 of Example 1 was prepared. In addition, an amino silane, 3-aminopropyltriethoxysilane KBE 903 from Shin Etsu without any dilution was used. The amino silane was first mixed with the wollastonite before adding to the polyurethane, to fully coat or “wet out” the wollastonite particles.

Surprisingly, Sample 13 which included wollastonite and the amino silane compound had about twice the strength of Sample 12 which had wollastonite without an amino silane. Furthermore, Sample 13 provided good strength in a relatively light weight part.

### Example 3

### Pallet

The following describes the preparation of a 40×48 inch flat top, nine post pallet that was manufactured in two pieces, a top and bottom, which were glued together. Two aluminum (top and bottom of pallet) two piece molds (top and bottom of mold) were prepared in the shape of both the top of and the bottom of the pallet and coated with Stoner M883 mold release to facilitate easy release of the part after manufacture. The mold for the top half of the pallet was then heated to 120° F.

The outside, impact resistant layer or skin was added to the mold. Six pounds of an A/B two part urethane compound, VFI 207 from Volatile Free, Inc., was applied to the mold, covering both the top and bottom parts of the mold with a layer approximately 1/16th inch in thickness. Application of the material to the mold was made using a Graco 20/35 spray unit equipped with a fusion spray gun. The VFI 207 urethane is formulated to be a very quick cross link/cure material and cured almost immediately upon application to the mold.

Next, the strength layer was added to the mold. In this trial run, the epoxy layer was hand mixed (although a sprayer such as a Graco or Glasscraft sprayer could be used for mixing and application). The strength layer consisted of a total of 4 pounds of Dow D.E.R. 383 epoxy to which a Dow D.E.H. 29 hardner was added. The ratio of epoxy to hardener was 84/16. Two pounds of chopped strand fiberglass (gun roving) was added to the epoxy. This chopped strand was hand mixed with the epoxy prior to adding the mix to the mold. (Alternatively, glass can be added mechanically using a chopper gun such as a GlassCraft product.) Two pounds of treated expanded volcanic ash, Kamco 5, from Kansas Minerals was pre-treated with SCA 960 epoxy silane obtained from Struktol Corporation of Stow, Ohio, and added to the mix.

The core material was then added to the mold. A Delta RIM machine from Graco was used to mix 12 pounds of VFI 742 NB part foamable rigid polyurethane with an added four pounds of NYAD WOLLASTOCOAT G wollastonite from NYCO Minerals pre-treated with KBE 903 amino silane coupling agent purchased from Shin Etsu. The mixture was dispensed by the Delta RIM machine into the mold, and the mold was closed and left to cure. The cure time of the foaming polyurethane was 12 minutes, during which time the heat from the polyurethane reaction also hastened the curing of the epoxy strength layer such that the part was cured in 12 minutes' time. The same process was followed for the bottom of the pallet. The two halves of the pallet were glued together using VFI 3037 adhesive from Volatile Free, Inc. to obtain the complete pallet.

What is claimed is:

1. A composite matrix material comprising:
(a) polyurethane;
(b) inorganic particles which have outer surfaces and an aspect ratio of from at least about 1.5 to about 30; and
(c) a silane coupling agent;
wherein at least a portion of outer surfaces of the inorganic particles are in contact with the silane coupling agent.

2. The composite matrix material of claim 1 wherein the polyurethane is a foamed polyurethane.

3. The composite matrix material of claim 1 wherein the inorganic particles have an aspect ratio of from about 5 to about 25.

4. The composite matrix material of claim 1 wherein the inorganic particles are from about 5 to about 80 weight percent based on the weight of the composite matrix material.

5. The composite matrix material of claim 1 wherein the inorganic particles contain silicon molecules.

6. The composite matrix material of claim 5 wherein the inorganic particles are wollastonite particles.

7. The composite matrix material of claim 1 wherein the coupling agent is in an amount of from about 0.4 to about 5 weight percent based on the weight of the inorganic particles.

8. The composite matrix material of claim 7 wherein coupling agent is in an amount of from about 0.5 to about 1.5 weight percent based on the weight of the inorganic particles.

9. The composite matrix material of claim 1 wherein the silane coupling agent is an amino or an epoxy silane coupling agent.

10. The composite matrix material of claim 9 wherein the silane coupling agent is selected from the group consisting of:
N-2-(aminoethyl)-3-aminopropylmethyldimethoxysilane,
N-2-(aminoethyl)-3-aminopropyltrimethoxysilane,
N-2-(aminoethyl)-3-aminopropyltriethoxysilane,
3-aminopropyltrimethoxysilane,
3-aminopropyltriethoxysilane,
3-triethoxysilyl-N-(1,3-dimethyl-butyliden) propylamine,
N-phenyl-3-aminopropyltrimethoxysilane,
N-(vinylbenzyl)-2-aminoethyl-3-aminopropyltrimethoxysilane hydrochloride,
2-(3,4-epoxycyclohexyl)-ethyltrimethoxysilane,
and mixtures of any of the foregoing.

11. The composite matrix material of claim 9 wherein the silane coupling agent is an amino silane coupling agent.

12. The composite matrix material of claim 11 wherein the silane coupling agent is selected from the group consisting of 3-aminopropyltriethoxysilane and 3-triethoxysilyl-N-(1,3-dimethyl-butyliden) propylamine.

13. The composite matrix material of claim 1 further comprising a low density filler selected from the group consisting of expanded volcanic ash, pumice, perlite, pumiscite, vermiculite, glass microspheres, soybean hulls, rice hulls, polymeric microspheres, cenospheres, and mixtures of any of the foregoing.

14. The composite matrix material of claim 13 wherein the low density filler is selected from the group consisting of expanded volcanic ash and mixtures comprising expanded volcanic ash.

15. The composite matrix material of claim 1 wherein the polyurethane is from about 30 to about 90 weight percent polyurethane based on the weight of the composite matrix material.

16. The composite matrix material of claim 1 which has a density of from about 0.1 to about 0.7 grams per cubic centimeter.

17. The composite matrix material of claim 1 which has a flexural modulus of from about 50,000 to about 150,000 pounds per square inch, and a shear modulus of from about 50 to about 500 pounds per square inch.

18. A composite matrix material of claim 1 wherein the (a) polyurethane, the (b) inorganic particles, and the (c) silane coupling agent comprise a polymeric matrix layer which has at least one surface, and wherein the composite matrix material further comprises a skin which is adhered to at least a portion of the surface of the polymeric matrix layer.

19. The composite matrix material of claim 18 wherein the skin comprises paint or a thermoset resin selected from the group consisting of polyureas, acrylics, non-rigid, non-foaming polyurethanes, and epoxies, and wherein the thermoset resin optionally comprises a low density filler or a reinforcing filler.

20. A composite matrix material comprising:
(a) polyurethane;
(b) silicon-containing inorganic particles which have outer surfaces and an aspect ratio of from about 10 to about 25; and
(c) an amino silane coupling agent;
wherein the outer surfaces of the silicon-containing inorganic particles are in contact with the amino silane coupling agent and the amino silane coupling agent is in an amount of from about 0.5 to about 5 weight percent based on the weight of the inorganic particles.

21. The composite matrix material of claim 20 wherein the polyurethane is a foamed polyurethane.

22. The composite matrix material of claim 20 wherein the inorganic particles are wollastonite particles.

23. The composite matrix material of claim 20 wherein the amino silane coupling agent is in an amount of from about 0.5 to about 1.5 weight percent based on the weight of the inorganic particles.

24. The composite matrix material of claim 20 which has a density of from about 0.1 to about 0.7 grams per cubic centimeter, a flexural modulus of from about 50,000 to about 150,000 pounds per square inch, and a shear modulus of from about 50 to about 500 pounds per square inch.

25. The composite matrix material of claim 20 wherein the (a) polyurethane, the (b) silicon-containing inorganic particles, and the (c) amino silane coupling agent comprise a polymeric matrix layer which has at least one surface, and wherein the composite matrix material further comprises a skin which is adhered to at least a portion of the surface of the polymeric matrix layer, and the skin comprises paint or a thermoset resin selected from the group consisting of polyureas, acrylics, non-rigid, non-foaming polyurethanes, and epoxies, and wherein the thermoset resin optionally comprises a low density filler or a reinforcing filler.

26. A composite comprising:
(i) a polymeric matrix core which has a surface, wherein the polymeric matrix core comprises:
(a) polyurethane;
(b) inorganic particles which have outer surfaces and an aspect ratio of from at least about 1.5 to about 30; and
(c) a silane coupling agent;
wherein at least a portion of outer surfaces of the inorganic particles are in contact with the silane coupling agent; and
(ii) a thermoset layer which is bonded to at least a portion of the surface of the polymeric matrix core.

27. The composite of claim 26 wherein the polyurethane is a foamed polyurethane.

28. The composite of claim 26 wherein the inorganic particles have an aspect ratio of from about 5 to about 25.

29. The composite of claim 26 wherein the inorganic particles are from about 5 to about 80 weight percent based on the weight of the polymeric matrix core.

30. The composite of claim 26 wherein the inorganic particles contain silicon molecules.

31. The composite of claim 30 wherein the inorganic particles are wollastonite particles.

32. The composite of claim 26 wherein the coupling agent is in an amount of from about 0.4 to about 5 weight percent based on the weight of the inorganic particles in the polymeric matrix core.

33. The composite of claim 32 wherein the coupling agent is in an amount of from about 0.4 to about 1.5 weight percent based on the weight of the inorganic particles.

34. The composite of claim 26 wherein the silane coupling agent is an amino or an epoxy silane coupling agent.

35. The composite of claim 34 wherein the silane coupling agent is selected from the group consisting of:
N-2-(aminoethyl)-3-aminopropylmethyldimethoxysilane,
N-2-(aminoethyl)-3-aminopropyltrimethoxysilane,
N-2-(aminoethyl)-3-aminopropyltriethoxysilane,
3-aminopropyltrimethoxysilane,
3-aminopropyltriethoxysilane,
3-triethoxysilyl-N-(1,3-dimethyl-butyliden) propylamine,
N-phenyl-3-aminopropyltrimethoxysilane,
N-(vinylbenzyl)-2-aminoethyl-3-aminopropyltrimethoxysilane hydrochloride, and
2-(3,4-epoxycyclohexyl)-ethyltrimethoxysilane,
and mixtures of any of the foregoing.

36. The composite of claim 34 wherein the silane coupling agent is an amino silane coupling agent.

37. The composite of claim 36 wherein the silane coupling agent is selected from the group consisting of 3-aminopropyltriethoxysilane and 3-triethoxysilyl-N-(1,3-dimethyl-butyliden) propylamine.

38. The composite of claim 26 wherein the polymeric matrix core is comprised of from about 30 to about 90 percent polyurethane based on the weight of the polymeric matrix core.

39. The composite of claim 26 wherein the polymeric matrix core or the thermoset layer each independently further comprise a low density filler.

40. The composite of claim 39 wherein the low density filler is selected from the group consisting of expanded volcanic ash, pumice, perlite, pumiscite, vermiculite, glass microspheres, soybean hulls, rice hulls, polymeric microspheres, cenospheres, and mixtures of any of the foregoing.

41. The composite of claim 40 wherein the low density filler is selected from the group consisting of expanded volcanic ash and mixtures comprising expanded volcanic ash.

42. The composite of claim 39 wherein when the polymeric matrix core comprises low density filler, it is present up to about 40 percent by weight based on the weight of the polymeric matrix core.

43. The composite of claim 26 wherein the inorganic particles are wollastonite particles, and the polymeric matrix core further comprises a low density filler which is expanded volcanic ash or mixtures comprising expanded volcanic ash.

44. The composite of claim 43 wherein the wollastonite and the expanded volcanic ash are in a ratio of from 45:55 to 55:45 by volume, and the wollastonite and the expanded volcanic ash are from about 5 to about 40 percent by volume of the polymeric matrix core.

45. The composite of claim 26 wherein the polymeric matrix core or the thermoset layer each independently further comprise a reinforcing filler selected from the group consisting of glass fiber, carbon fiber, cellulosic fiber, mineral filler other than low density mineral filler, glass microspheres, soybean hulls, rice hulls, polymeric microspheres, cenospheres, and blends of any of the foregoing.

46. The composite of claim 45 wherein the mineral filler other than low density mineral filler is selected from the group consisting of silica, talc, calcium carbonate, mica, kaolin, wollastonite, feldspar, barytes, volcanic ash, and mixtures of any of the foregoing.

47. The composite of claim 45 wherein when the reinforcing filler is present in the polymeric matrix core, it is up to about 70% weight percent based on the weight of the polymeric matrix core.

48. The composite of claim 45 wherein the glass fiber is selected from the group consisting of fiberglass roving and chopped strand.

49. The composite of claim 45 wherein the glass fiber is up to about 50% by volume of the thermoset layer.

50. The composite of claim 26 wherein the thermoset of the thermoset layer is selected from the group consisting of epoxies, non-foamed polyurethanes, phenol-resorcinol polymers, urea-formaldehyde polymers, polyureas, phenol-formaldehyde polymers, melamine-formaldehyde polymers, soy-based polymers, polyesters, polyimides, acrylics, cyanoacrylates, polyanhydrides, polydicyclopentadienes, polycarbonates, blends of any of the foregoing, and blends of any of the foregoing with at least one linseed oil-based polymer.

51. The composite of claim 50 wherein the thermoset is epoxy or a blend of thermosets comprising epoxy.

52. The composite of claim 26 which has a specific gravity of from about 0.20 grams per cubic centimeter to about 2 grams per cubic centimeter.

53. The composite of claim 26 which has a modulus of elasticity of from about 1,000,000 to about 2,500,000 pounds per square inch, and a shear modulus of from about 2,000 to about 8,000 pounds per square inch.

54. The composite of claim 26 which has an outer surface, and the composite further comprises a skin which is adhered to at least a portion of the outer surface of the composite.

55. The composite of claim 54 wherein the skin comprises paint or a thermoset resin selected from the group consisting of polyureas, acrylics, non-rigid, non-foaming polyurethanes, and epoxies, and wherein the thermoset resin optionally comprises a low density filler or a reinforcing filler.

56. The composite of claim 54 wherein the composite further comprises an additive selected from the group consisting of ultraviolet protectants, compatibilizers, antioxidants, glass fibers, carbon fibers, cellulosic fibers, mineral fibers, heat stabilizers, colorants, flame retardants, insecticides, fungicides, plasticizers, tackifiers, processing aids, foaming agents, impact modifiers and proteins.

57. The composite of claim 26 wherein the composite has an outer surface and at least one layer of fibrous material is adhered or bonded to at least a portion of the outer surface of the composite.

58. A composite comprising:
(i) a polymeric matrix core which has a surface, wherein the polymeric matrix core comprises:
(a) polyurethane;
(b) silicon-containing inorganic particles which have outer surfaces and an aspect ratio of from about 5 to about 25; and
(c) an amino silane coupling agent;
wherein the outer surfaces of the silicon-containing inorganic particles are in contact with the amino silane coupling agent and the amino silane coupling agent is in an amount of from about 0.5 to about 5 weight percent based on the weight of the inorganic particles; and
(ii) a thermoset layer which is bonded to at least a portion of the surface of the core.

59. The composite of claim 58 wherein the polyurethane is a foamed polyurethane.

60. The composite of claim 58 wherein the inorganic particles are wollastonite particles.

61. The composite of claim 58 wherein the coupling agent is in an amount of from about 0.5 to 1.5 weight percent based on the weight of the inorganic particles.

62. The composite of claim 61 wherein the coupling agent is in an amount of about 1 weight percent based on the weight of the inorganic particles.

63. The composite of claim 58 wherein the thermoset of the thermoset layer is epoxy or mixtures comprising epoxy.

64. The composite of claim 58 which has a density of from about 0.2 to about 0.8 grams per cubic centimeter, a modulus of elasticity of from about 1,000,000 to about 2,500,000 pounds per square inch, and a shear modulus of from about 2,000 to about 8,000 pounds per square inch.

65. The composite of claim 58 wherein each of the core or the thermoset layer each independently further comprise a filler selected from the group consisting of a low density filler or a reinforcing filler.

66. The composite of claim 65 wherein the filler comprises expanded volcanic ash or mixtures comprising expanded volcanic ash.

67. A composite comprising:
(i) a polymeric matrix core which has a surface, wherein the polymeric matrix core comprises:
(a) polyurethane;
(b) inorganic particles which have outer surfaces and an aspect ratio of from at least about 1.5 to about 30; and
(c) a silane coupling agent;
wherein at least a portion of outer surfaces of the inorganic particles are in contact with the silane coupling agent; and
(ii) a laminate bonded to at least a portion of the surface of the core, the laminate comprising:
(a) at least one layer of fibrous material having a surface, and
(b) at least one layer of thermoset binder which is bonded to at least a portion of the surface of at least one layer of fibrous material, and wherein each thermoset binder layer optionally comprises a low density filler.

68. The composite of claim 67 wherein the laminate thermoset binder layer comprises the low density filler which is expanded volcanic ash or blends comprising expanded volcanic ash.

69. The composite of claim 67 wherein the polyurethane is a foamed polyurethane.

70. The composite of claim 67 wherein the inorganic particles are wollastonite particles, and wherein the silane coupling agent is an amino silane coupling agent.

71. The composite of claim 67 which further comprises a thermoset layer which is bonded to at least a portion of the surface of the polymeric matrix core, and said thermoset layer optionally comprises a low density filler or a reinforcing filler.

72. A pallet sheet for carrying one or more objects, the pallet sheet comprising:
(a) a composite according to claim 58 that has at least one surface on which the one or more objects rest when being carried on the pallet sheet and wherein the at least one surface defines at least one notch to facilitate moving the pallet; and
(b) a skin bonded to at least a portion of the surface of the composite.

73. A pallet for carrying one or more objects, the pallet comprising:
(a) a composite according to claim 58 that has at least one surface on which the one or more objects rest when being carried on the pallet and at least one side and wherein the at least one side defines at least one notch to facilitate moving the pallet;
(b) a skin bonded to at least a portion of the surface of the composite; and
(c) posts connected to the composite.

74. A pallet for carrying one or more objects, the pallet comprising:
(a) at least two composites, wherein at least one of the composites is a composite of claim 58 that has at least one surface on which the one or more objects rest when being carried on the pallet and at least one side and wherein the at least one side defines at least one notch to facilitate moving the pallet;
(b) a skin bonded to at least a portion of the surface of the at least one composite; and
(c) at least two posts, wherein each of the posts is connected to one of the composites such that the posts define a space between the composites when the composites are placed with the posts between them.

75. A deck board comprising a composite of claim 58 wherein the composite has an outer surface and a skin is adhered to the outer surface and the skin comprises a substance selected from the group consisting of polyureas, acrylics, non-rigid, non-foaming polyurethanes, epoxies, paints, reinforcing fillers, ultraviolet protectants, impact modifiers, antioxidants, low density fillers, wood colorants, impact modifiers, heat stabilizers, flame retardants, insecticides, and fungicides.

76. A siding or roofing panel comprising a composite of claim 58 wherein the composite has an outer surface and a skin is adhered to the outer surface and the skin comprises a substance selected from the group consisting of polyureas, acrylics, non-rigid, non-foaming polyurethanes, epoxies, paints, reinforcing fillers, ultraviolet protectants, impact modifiers, antioxidants, low density fillers, wood colorants, impact modifiers, heat stabilizers, flame retardants, insecticides, and fungicides.
